(19) United States
(12) Patent Application Publication
(10) Pub. No.: US 2010/0306738 A1
(43) Pub. Date: Dec. 2, 2010

(54) TEMPLATING SYSTEM AND METHOD FOR UPDATING CONTENT IN REAL TIME

(76) Inventors: Ravi Verma, Haryana (IN); Manish Thakur, Haryana (IN)

Correspondence Address: LESTER H. BIRNBAUM, 6 OAKMOUNT COURT, SIMPSONVILLE, SC, 29681, US

(21) Appl. No.: 12/734,798

(22) PCT Filed: Dec. 2, 2008
(86) PCT No.: PCT/IN2008/000799

§ 371 Date: May 25, 2010

(30) Foreign Application Priority Data
Dec. 3, 2007 (IN) 2524/DEL/2007

(51) Int. Cl. G06F 17/00; G06F 9/44; G06F 17/30

(52) U.S. Cl. 717/115; 715/234; 707/803; 707/E17.044

(57) ABSTRACT

A templating system is provided. The templating system separates the fixed and dynamic parts of a code from a template. The fixed part is maintained at the client end and the dynamic part is maintained at the server end of a network. The templating system processes the fixed parts, dynamic parts, and a data model together to generate a result document. The result document is updated at the client end in real time by transmitting only the dynamically changing components of the code from the server end to the client end.

### FIELD OF THE INVENTION

The invention relates generally to the field of templating systems. More specifically, the invention relates to a templating system which generates dynamically updating content.

### BACKGROUND OF THE INVENTION

In today's world when there is rapid development of the World Wide Web (WWW), users frequently need to access various web-based applications. Web pages provide a communication medium for users who wish to interact with these web-based applications. With the continuous ongoing development of various standards such as Hyper Text Transfer Protocol (HTTP), Hyper Text Markup Language (HTML), eXtensible HTML (XHTML), Dynamic HTML (DHTML), JavaScript, J2EE etc, the structure and format of a web page has evolved exponentially.

Typically, a web page is created using a markup language such as HTML. Markup languages combine relevant data and additional information such as the structure and layout of the web page. HTML includes a scripting language code that affects the representation of a document on a web-browser. Web-based applications are controlled by these scripting language codes. Scripts are segments of code, rather than complete programs, are directly executed from their code, embedded in a markup language.

A web page can be created by using a template. A template is a processing element, which when processed with data using a templating engine generates a web page. The templating engine can also produce documents and source codes. The templating engine is software that combines a number of templates with a data model to produce a result document such as a web page. Examples of templating engines include, but are not limited to, Java Server Pages (JSP) and Active Server Pages (ASP).

A web page needs to be updated on a web-browser, when there is a change in the data. Refreshing a web page signifies re-generating the content of the web page to reflect the modifications. However, frequent refreshing of the web page is not desirable due to amount of time and network traffic required for refreshing the web page. Moreover, the browsing experience of a user is adversely hampered by frequent refreshing. To overcome this problem, web pages can be generated and updated dynamically in response to the modifications.

Dynamic updating can be achieved by using client side or server side scripting. In client side scripting, the dynamic changes are made within the web page in response to events. Examples of events include mouse clicks, keystrokes, or dynamic changes at specified time intervals. In server side scripting, the dynamic changes are made to the web page by running a script directly at the server. Further, in server side scripting, sequence or reload of the web page or web-content supplied to the browser is adjusted at the server side. Client side scripting and server side scripting can also be used simultaneously.

In traditional server side scripting, a web page is required to be processed completely to reflect any dynamic changes which may occur in the underlying data. The templating engine does not always take care of detecting any changes to the underlying data. Moreover, templating engine does not generate minimal changes to the result document to reflect the changes automatically. Therefore, a code to check and reflect the changes in the underlying data is specifically written manually.

In light of the foregoing, there exists a need for providing a templating system and computer implemented method for dynamically updating a web page. The templating system should detect changes in the underlying data and generate minimal changes to the result document to reflect those changes automatically. Further, the templating system should eliminate the probability of a human programmer writing a code to check for, and reflect the desired changes in the underlying data. The templating system should generate web-based applications that reflect any changes to the data or layout and structure of the web page in real-time. Moreover, the templating system should generate web-based applications that support real-time data validation, auto-completion, partial data submit, and auto-refresh among other things. The templating system should also be compatible with various markup and scripting languages.

### SUMMARY

Embodiments of the invention provide a templating system that separates the fixed and dynamic parts of a code from a template. The fixed part is maintained at the client end and the dynamic part is maintained at the server end of a network. The templating system processes the fixed parts, dynamic parts, and a data model together to generate a result document. The result document is updated at the client end in real time by transmitting only the dynamically changing components of the code from the server end to the client end.

### BRIEF DESCRIPTION OF THE DRAWINGS

The preferred embodiments of the invention will hereinafter be described in conjunction with the appended drawings, provided to illustrate and not to limit the invention, wherein like designations denote like elements, and in which:

FIG. 1 is a schematic of a network, where some embodiments of the invention can be practiced;

FIG. 2 illustrates a template in accordance with various embodiments of the invention;

FIG. 3 illustrates a templating system, in accordance with various embodiments of the invention;

FIG. 4 is a schematic of the compilation process of a templating engine, in accordance with various embodiments of the invention;

FIG. 5 is a schematic of the instantiation process of a templating engine, in accordance with various embodiments of the invention; and

FIG. 6 illustrates real time updating of a result document, in accordance with various embodiments of the invention.

### DESCRIPTION OF EMBODIMENTS

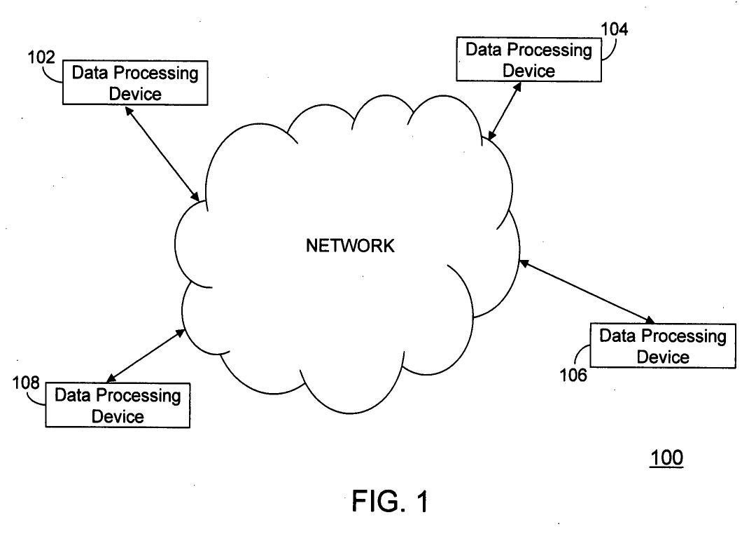

FIG. 1 is a schematic of a network 100 where some embodiments of the invention can be practiced. Those skilled in the art will however recognize and appreciate that the specifics of this illustrative example are not the specifics of the invention itself, and that the teachings set forth herein can be applicable in a variety of alternative settings. For example, since the teachings described do not depend on the network devices 102, 104, 106, and 108, they can be applied to any type of network device. As such, other alternative implementations of using different types of network devices are contemplated and are within the scope of the various teachings described. Further, some embodiments of the invention can also be practiced on a standalone data processing device such as a desktop computer, a laptop, a PDA etc.

Network 100 includes a data processing device 102, a data processing device 104, a data processing device 106, and a data processing device 108 which will be hereinafter collectively referred to as ‘data processing devices’. Network 100 is an interconnected system of data processing devices and a network cloud as shown in FIG. 1. Examples of network 100 include, but are not limited to, Local Area Networks (LANs), Wide Area Networks (WANs), satellite networks, telecommunications networks, wireless networks, and wireline networks. Examples of data processing devices include, but are not limited to, computers, laptops, mobile phones, Personal Digital Assistants (PDAs), servers, routers and switches.

Data can be exchanged between the data processing devices through network 100. In various embodiments of the invention, the data processing devices are arranged in network 100 in a client-server model, peer-to-peer model, or other models for communication between the data processing devices. Further, some embodiments of the invention can also be practiced on a standalone data processing device such as a desktop computer, a laptop, a PDA etc. Network 100 is described hereinafter based on the client-server model, but it will be apparent to those skilled in the art, that the present invention can be implemented to any other model as well. In a client server model, the client can add data to, and retrieve data from the server.

In an embodiment of the invention, data processing device 102 is a server and data processing device 104 is a client. Hereinafter, the terms data processing device 102 and server are used interchangeably. Similarly, the terms data processing device 104 and client are used interchangeably. The client requests the server for a service. In an embodiment of the invention, the service is a templating system based service. For example, the service provides a document generated based on a template to the client. The service is described in context of a web-based application, which results in a document displayed at the client in a web-browser. Therefore, the service can be hereinafter referred interchangeably as the ‘result document’.

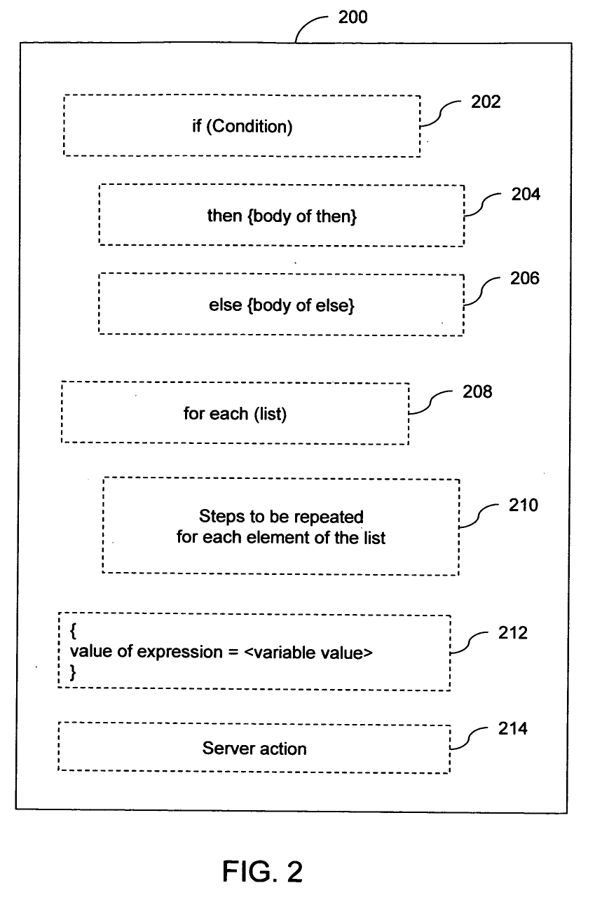

In the templating system, the document is generated based on a template. The template is a prototype of a set of content and commands to be included in the result document. In other words, the template is a processing element that can be combined with a data model and can be processed together with the data model to generate the result document. The template is described further in detail in conjunction with FIG. 2.

FIG. 2 illustrates a template 200 in accordance with various embodiments of the invention. As described in conjunction with FIG. 1, template 200 includes a set of instructions that are processed together with data from a data model to generate the result document. The data model determines the representation of the data. Template 200 provides a skeletal framework to represent the result document. For example, a template for an online banking transaction system is an outline for representing information pertaining to a bank account, such as an account number, name of account holder, transactions carried out, amount involved in the transactions etc. In this case, the data model is the records of the transactions conducted by users. These records are stored in a database on a server of the bank. The template and the data model are processed together to generate the result document. The result document can be the account statement of the user that can be displayed on the terminal of the user in a Graphical User Interface (GUI).

In an embodiment of the invention, template 200 is a document based on a markup language. Template 200 includes segments of the code, which are part of the markup language, and segments of a templating language. In an embodiment of the invention, the markup language used is eXtensible Hyper Text Markup Language (XHTML). In various embodiments of the invention, the markup language used is Hyper Text Markup Language (HTML), eXtensible Markup Language (XML), a variant of XML or any other Generalized Markup language (GML). According to another embodiment of the invention, a combination of Microsoft Silverlight and JavaScript or a combination of Adobe Flash and Actionscript can be used. When the invention is practiced on a standalone data processing device, a new markup language can be developed and used, along with a scripting language such as JavaScript.

The segments of the markup language and the templating language can be defined by the creator of template 200. The set of instructions in template 200 can be in the form of various logical steps that need to be followed to generate the result document. These different segments of the template can be classified according to their functions, the type of data they hold (static or dynamic) etc. For easier understanding, segments are represented as general control constructs such as ‘if’, ‘else’, ‘for-each’, variable declaration, variable assignments by expressions etc. of a markup or a scripting language, in FIG. 2. One such control construct is ‘make-comp’. The ‘make-comp’ control construct is used to instantiate a component. Instantiation is a process of invoking a segment of code. The component is a program or code snippet that may be repeated multiple times during the execution of a code. The component can be a part of another code other than the one being executed. It will be appreciated by those skilled in the art that the component can be understood analogous to a ‘module’ in a programming language, which is defined globally, and can be invoked multiple times during execution of a code.

It will be appreciated by those skilled in the art that the actual constructs in a template can vary according to the needs and efficiency required by the server and the client. Different segments of the template 200 can be classified as ‘Blocks’, ‘Block Holders’, and ‘Expression Holders’. In addition, control constructs such as variable declaration and Server Actions can also be included in template 200.

A ‘Block’ is the segment of the template that either occurs as a whole in the result document or does not occur at all. For example, the portions of ‘then’ statement, and the portions of ‘else’ statement in an If-Then-Else construct can be classified as two Blocks. Whether or not a Block occurs in the result document depends on a ‘Block Holder’ of the Block. In general, the Block Holder is a conditional statement that determines the occurrence of the Block corresponding to the Block Holder. For example, the control constructs ‘if’ and ‘for-each’ are Block Holders. In template 200, a Block Holder 202 corresponds to a Block 204 and a Block 206. Similarly, a Block Holder 208 corresponds to a Block 210. An ‘Expression Holder’ is a control construct that can be used by the creator of template 200 to assign or specify the values of the attributes or variables used in template 200 to serve the client. In an embodiment of the invention, the Expression Holder can be used as a part of the templating language used by the creator to embed the text in the result document. In another embodiment of the invention, the Expression Holder can be used to specify the value of the attributes of the markup language. For template 200, an Expression Holder 212 can be used to specify the attributes of the template 200. Template 200 may further include Server Actions. Server actions are the actions that need to be performed in response to an event, such as the movement of mouse over the text or images displayed in the result document.

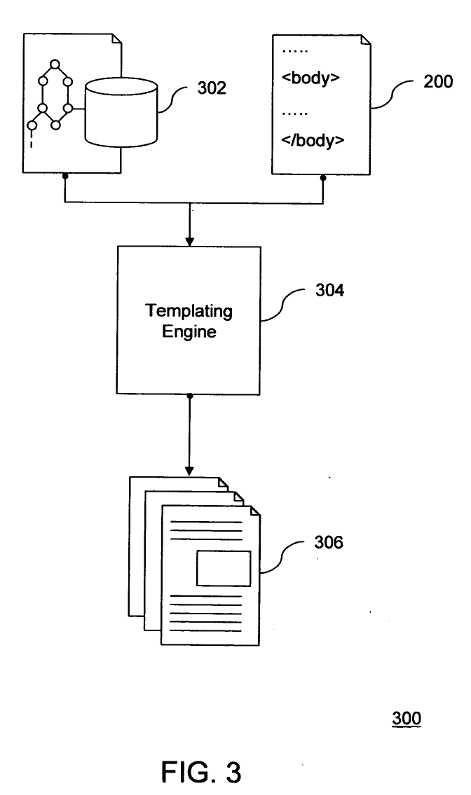

Template 200 and a data model can be processed by a templating engine to generate the result document. The templating engine is described in detail in conjunction with FIG. 3.

FIG. 3 illustrates a templating system 300, in accordance with various embodiments of the invention. In templating system 300, template 200 is processed together with a data model 302 by a templating engine 304. Reference will be made to FIGS. 1 and 2, although it will be apparent to those skilled in the art that the present invention can work in embodiments that are different from the one described above. Data model 302 determines how data can be used or represented. Data model 302 along with template 200 can be used to generate a result document 306 by using templating engine 304. Templating engine 304 can determine the segments of the code from template 200 that is to be used to generate result document 306.

For example, in the case of an online banking system, template 200 can contain instructions for generating a Graphical User Interface (GUI) that displays account transactions, scheduled bills, loans etc on a user terminal. In this event, result document 306 is displayed on the GUI of the user terminal. Data model 302 contains records that represent the data values of the amounts corresponding to account transactions, scheduled bills, loans, etc. Templating engine 304 can determine, based on the request, the relevant fields to be displayed in result document 306. Result document 306 can only display information for the transactions involving scheduled bills or loans.

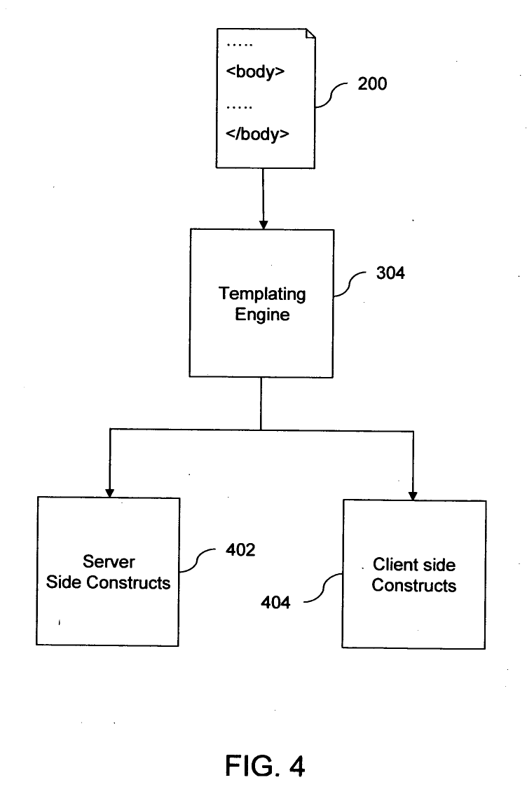

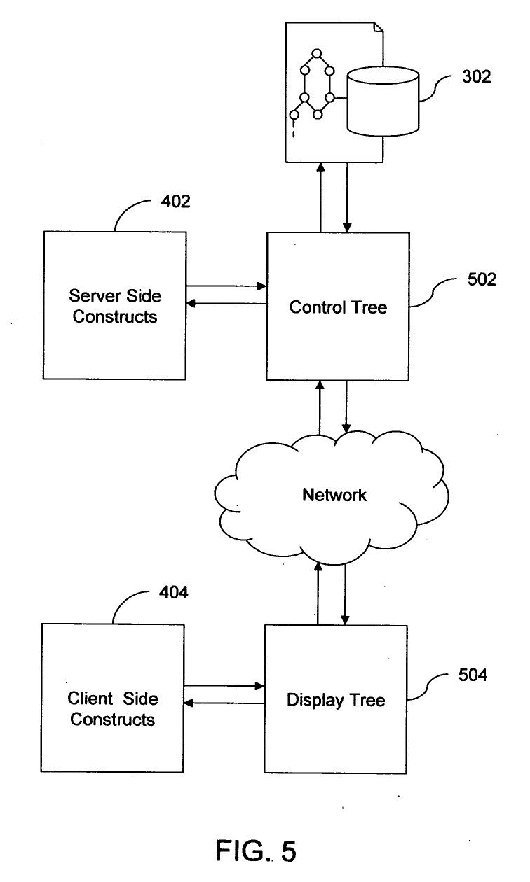

Templating engine 304 therefore performs loading, compilation and instantiation of template 200. Further, templating engine 304 performs generation and dynamic updating of result document 306. Compilation and instantiation of template 200 by templating engine 304 is described in detail in conjunction with FIG. 4 and FIG. 5.

FIG. 4 is a schematic of the compilation process of templating engine 304, in accordance with various embodiments of the invention. Reference will be made to FIGS. 1, 2 and 3, although it will be apparent to those skilled in the art that the present invention can work in embodiments that are different from the one described above. Templating engine 304 compiles template 200 to generate server side constructs 402 and client side constructs 404.

Template 200 is broken down in the compilation process into control constructs that are present in template 200, and the client side scripting language code. Templating engine 304 can generate server side constructs 402 and client side constructs 404, that are processed at the server and at the client respectively. In an embodiment of the invention, client side constructs 404 is sent to the client and can be cached on the client.

In the compilation process, the parts of the template document are identified as a ‘dynamic’ part or a ‘fixed’ part. The dynamic part of the code is the segment of the code in template 200 that changes with changes in the data model 302. The fixed part is the segment of code that does not depend directly on the attributes that change in real time. However, the fixed part can reflect the effects of changes in the dynamic part.

In an embodiment of the invention, the fixed part of the code in template 200 becomes a part of a markup language. For example, the fixed part can be the segments of the code from the markup language that give directives for display attributes such as background color, font type etc. The fixed part of template 200 is a part of client side constructs 404. Further, the dynamic part of template 200 is a part of server side constructs 402. As described in conjunction with FIG. 2, the control constructs are classified as Block, Block Holders, Expression Holders, Server Actions and ‘make-comp’ control construct. In an embodiment of the invention, the Block and Block Holders include fixed parts and dynamic parts. The fixed parts of the Block and Block Holder are included in client side constructs 404, and the dynamic parts of the Block and Block Holders are included in server side constructs 402. Expression Holders are the dynamic parts of the code. Therefore, Expression Holder 212 is a part of server side constructs 402. Server side constructs 402 also includes Blocks and Block Holders of template 200. Further, the Blocks and Block Holders in client side constructs 404 correspond to the Blocks and Block Holders in server side constructs 402. Typically, the dynamic part is much smaller as compared to the fixed part. Moreover, the server only needs to maintain the dynamic part of the code. Therefore, the memory requirement at the server is reduced.

Server side constructs 402 and client side constructs 404 have a tree data structure. A tree data structure is a way of representing the hierarchical structure of data in graphical form. The tree data structures known in the art include a set of linked nodes. A node may contain a value, a condition, or a tree originating from the node. Hereinafter, the term ‘tree data structure of server side constructs 402’ is interchangeably referred to as ‘control tree prototype’. The tree data structure is referred to as prototype, since the prototype can be used by templating engine 304 to serve the client in the instantiation process. The instantiation process performed by templating engine 304 is described in detail in conjunction with FIG. 5.

The control tree includes nodes such as variable declarations, variable assignments, Blocks, Block Holders, Expression Holders and Server Actions. The tree data structure at client side constructs 404 includes nodes such as the fixed part of markup language, Blocks and Block Holders. Further, each Block in the control tree prototype has a unique identifier that is referred to as the ‘block type’ associated with it. The Blocks of client side constructs 404 have the same ‘block type’ that corresponds to their respective Blocks present in the control tree prototype. For example, when JavaScript is used as a scripting language for client side constructs 404, a function with same name as that of the ‘block type’ acts as a link between server side constructs 402 and client side constructs 404. When the function is invoked, a display that corresponds to the Block can be generated.

FIG. 5 is a schematic of the instantiation process of templating engine 304, in accordance with various embodiments of the invention. Reference will be made to FIGS. 1, 2, 3 and 4, although it will be apparent to those skilled in the art that the present invention can work in embodiments that are different from the one described above. As described in conjunction with FIG. 4, the compilation process of templating engine 304 generates server side constructs 402 (the control tree prototype) and client side constructs 404. The instantiation process of templating engine 304 occurs when the client makes a request for the display of information from template 200.

The control tree prototype instantiates a control tree 502. Control tree 502 is similar in structure to the control tree prototype. Control tree 502 is composed of the active server side constructs. The active server side constructs is the part of the server side constructs that contains specific information based on the request from the client and real time changes occurring in the data model; whereas, the control tree prototype is a general outline structure of the type of information present in template 200. Control tree 502 is composed of nodes which are in particular the active server side constructs.

Further, control tree 502 can be instantiated from more than one control tree prototypes when control construct ‘make-comp’ is used. As described in conjunction with FIG. 2, ‘make-comp’ is used to instantiate one or more components from other codes. In other words, the components instantiated by the ‘make-comp’ control constructs will result in multiple control tree prototypes being involved in instantiation of control tree 502. Similarly, the control tree 502 along with client side constructs 404 generates a display tree 504 at the client end. In other words, control tree 502 is an image of the control tree prototype with specific information as requested by the client.

Therefore, control tree 502 contains an image of Expression Holder 212, and holds specific values of the expressions in Expression Holder 212. Similarly images of the Block Holders and Blocks of the control tree prototype are present in control tree 502. These images of Block Holders within the control tree 502 hold specific values of the expressions, which decide the instantiation of the contained Blocks. For example, a Block Holder for ‘if’ control construct has specific value of its condition expression, and accordingly, contains either the ‘then’ block or the ‘else’ block. Similarly, the control tree prototype along with client side constructs 404 identifies the active client side constructs. The active client side constructs is the part of the client side constructs that needs to be executed to display the real time changes in the result document. The active client side constructs generates a display tree 504 at the client end. The display tree 504 includes Blocks and Block Holders that correspond to the control tree 502. As described in conjunction with FIG. 4, the Blocks and Block Holders of control tree 502 are related to the Blocks and Block Holders of display tree 504 by the corresponding ‘block type’. By relating the Blocks and Block Holders of control tree 502, the active client side constructs maps the active server side constructs. Display tree 504 is composed of nodes that are in particular the active client side constructs.

In an embodiment of the invention, control tree 502 is maintained at the client side, rather than at the server side. This results in a further reduction of memory requirement at the server. It will be apparent to a person skilled in the art that this does not restrict the scope of the invention in any way.

Control tree 502 interacts with data model 302 to determine the value of the attributes required to generate result document 306. In an embodiment of the invention, data model 302 is memory storage of the server. In another embodiment of the invention, data model 302 can be external memory storage in network 100.

For example, in an online stock trading system, the client makes a request for the stock prices of a particular share and advice on buying or selling the share. Data model 302 contains the data from the stock exchange database, which provides stock prices to the server. Further, control tree 502 obtains the latest stock prices from data model 302. Control tree 502 then sends the information of the stocks to display tree 504 to display the desired stock prices. Control tree 502 suggests buying or selling of stocks to the client based on the stock prices and other relevant factors. The Blocks and Block Holders of control tree 502 are instantiated based on the suggestion. Further, based on the “block type”, the Blocks and Block Holders of display tree 504 are also instantiated.

For this example, let us consider that depending on the current price of the stock, the control tree suggests buying the stock. The Expression Holder assigns the value to be displayed as the current stock price. Further, the Block Holder determines that the value to be displayed is for buying the stock. Therefore, the Blocks of control tree 502 that correspond to the code for buying the stock are instantiated. Furthermore, the Blocks and Block Holders of display tree 504 that correspond to the Blocks and Block Holders of control tree 502 are instantiated. Therefore, the client terminal displays result document 306 with the current stock prices and a suggestion to buy the stocks.

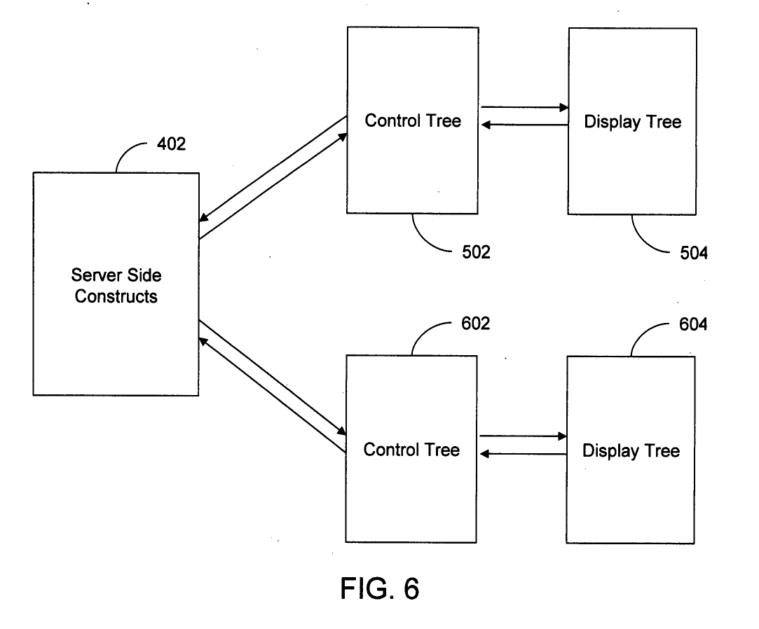

When the client is in communication with the server and the current price of the stock changes, the changes are sent to the client in real time. When the stock prices change and suggest selling of the stocks, the Blocks of display tree 504 that correspond to buying are no longer instantiated, and the Blocks of display tree 504 that correspond to selling of stocks are instantiated. Therefore, the Blocks and Block Holders of display tree 504 that correspond to the changing data are instantiated in real time to generate result document 306. The real time updating of result document 306 and tracking of changes in the values of the attributes is described in detail in conjunction with FIG. 6.

FIG. 6 illustrates real time updating of the result document 306, in accordance with various embodiments of the invention. Reference will be made to FIG. 1 through FIG. 5, although it will be apparent to those skilled in the art that the present invention can work in embodiments that are different from the one described above. It should be noted that more than one client can make a request for services to the server. Further, the server can simultaneously serve requests from more than one client.

As described in conjunction with FIGS. 3 and 4, templating engine 304 generates server side constructs 402 by processing template 200 along with data model 302. While the communication of the server (data processing device 102) and the client (data processing device 104) is in progress, another data processing device 106 can make a request to the server for a service. In this case, as explained in conjunction with FIG. 1 through FIG. 5, a control tree 602 and a display tree 604 are generated by templating engine 304. Since the generation of a control tree prototype for a given instance of a request does not depend on the specific values of attributes, control tree prototype 402 is the same for data processing device 104 and data processing device 106.

As described in conjunction with FIG. 1, data processing device 104 in the client-server model can add data to the server. The data is stored in the storage of the server. The server can retrieve the data from the storage. For example, in the case of a search engine, the data can be stored in the database of the search engine. Further, the request from data processing device 104 and data processing device 106 can be similar. In other words, in such a system, data processing device 104 and data processing device 106 can make a request for respective search results by using similar search terms.

Consider the example of a search engine that searches through a database. For clarity, we assume that data processing device 104 searches for all the documents in the database that include words starting with “app”. Result document 306 contains a display at data processing device 104, which is a list of all the documents that include one or more words starting with “app”. Therefore, the results include documents that contain words such as apple, apprehension, appendix etc. If we consider the number of results to be ‘n’, the search engine will return ‘n’ results. Further, data processing device 106 now adds a document to the database that contains the word “application”. If data processing device 104 is still in session with the server, the number of results at data processing device 104 increases by one (now becomes n+1) and the document added by data processing device 106 is displayed in the result document 306 in real time. In this way, the information at the client end can be updated in real time by the server.

During display of ‘n+1 ’ results at data processing device 104, only the data corresponding to the additional results, in this case, the (n+1)^{th} result, is sent by the server to data processing device 104. In other words, instantiation process for result document 306 does not need to be repeated for any change to be reflected at data processing device 104. Further, it should be appreciated by those skilled in the art that if the change from data processing device 106 results in decrease in number of results from ‘n’ to ‘m’ (m<n), then, only the data corresponding to this removal of n-m results will be removed from result document 306. The entire data of remaining ‘m’ results will not be transmitted from the server again. Further, instantiation process for the ‘m’ results will not be repeated.

Server side constructs 402, client side constructs 404, control tree 502, and display tree 504 have different nodes as described in FIGS. 4 and 5. It will be appreciated by those skilled in the art that there can be more than one variable declaration and variable assignments for each of the control tree prototype and control tree 502. Further, every time a block is instantiated as described above, the variable declarations and variable assignments for that block are also instantiated. Therefore, it is desired to have some way to track each of the variables and their specific value at a position and an instance of time.

In particular, tracking of variables is required at control tree 502, since the result document 306 is generated by using control tree 502. For this purpose, control tree 502 maintains a chain of variable value bindings in the same order in which the variable values are created. Every node in control tree 502 maintains a pointer to a location in this chain of variable values bindings (VarBindings). These pointers are helpful for tracking the VarBindings that occurred before the corresponding particular node. If an expression requires that the value of a variable involved in the expression is traced, the expression needs to trace backwards from the node that includes that expression. Tracking of VarBindings is required to update the value of the variables in the control tree 502, when there is a change in the data received from data model 302. Updating these values is required, because the change in the data can result in instantiation or removal of the different Blocks and Block Holders in control tree 502 from the changes instantiated earlier. This instantiation or removal will result in instantiation or removal of corresponding Blocks and Block Holders from display tree 504.

The segment of code that needs to be updated is determined at run-time. Therefore, it is not possible to have instructions that can register and de-register a node to change values manually. To automatically update result document 306, a mechanism is provided to indicate the availability of an update. For this purpose, the mechanism maintains two kinds of operators at templating engine 304. An ‘Information Retrieval Operator’ is used to retrieve data from data model 302 depending on parameters passed by data processing device 104. The Information Retrieval Operator is used in variable assignments and expressions, such as those in Block Holders. An ‘Information Change Operator’ is used to change the data in control tree 502 with change in values provided by data processing device 104. In an embodiment of the invention, Information Change Operators are part of the server actions.

The information retrieval operators maintain one or more tables of ‘listeners’ by registering the nodes of control tree 502, for the data to be retrieved at control tree 502. A listener is a node of control tree 502 that is registered to observe any change in data. The Information Change Operator updates data model 302 and schedules all the related listeners for re-evaluation. A node of control tree 502 maintains its set of listening points at run-time to know the places to de-register itself. This is achieved by providing a ‘speaker interface’. A speaker interface provides functions to register and de-register a listener. When an operator needs to register a listener, the operator creates a speaker object. The speaker object is added to a list of speakers provided to the operator by an expression. When the evaluation of the expression is carried out by the node, the node acquires a list of speaker objects. The node then registers itself with the speaker objects in the list. Further, on de-activation of the node, the node de-registers itself with the speaker objects in the list. Therefore, the mechanism described above results in a cleanup of listeners.

Let us take the example of the stock prices described in FIG. 5. A change in current stock prices may require changing the suggestion from buying stocks to selling stocks. Therefore, other variables such as the value at which the stock should now be sold, the type of graphical display etc. need to be re-evaluated to determine the data to be displayed in result document 306.

A re-evaluation of the expressions is carried out at different nodes. This leads to a re-evaluation of variable assignments among other things. A first node from which the re-evaluation of the expressions is carried out can be an Expression Holder, an assignment node or a Block Holder.

The changes are then repeated for the other nodes related to the first node according to a pre-defined logic. The re-evaluation is conducted in the depth-first-search (DFS) order. A list of the nodes ordered according to DFS which are to be re-evaluated and a set of ‘changed VarBindings’ is maintained. The changed VarBindings are empty at the beginning of the procedure and hold any VarBinding that change during this process. The pre-defined logic to choose the node after the first node for re-evaluation is as follows:

If the list of changed VarBindings is empty, re-evaluation is carried out from the next node in the list of the nodes to be re-evaluated. When the ‘changed VarBinding’ is not empty, control tree 502 is scanned from that node onwards in DFS order. Each node is first scanned to check whether it depends on changed VarBinding or it has been already scheduled for re-evaluation. Thereafter, re-evaluation is carried out for the node that first appears. This is done depending either on the changed VarBindings or based on whether the next node is scheduled for re-evaluation. Further, the nodes that have been re-evaluated from the list of nodes scheduled for re-evaluation are removed. Therefore, the head of the list is always the next node scheduled for re-evaluation in DFS order. The changed VarBinding may be removed from the list when another Assignment Statement assigns a value to the same variable, i.e., a changed VarBinding, or when the control goes out of the scope of the variable declaration of a changed VarBinding.

Further, the way in which re-evaluation is carried out, depends on whether the node is an Expression Holder, an Assignment node or a Block Holder.

When the node is an Expression Holder, the expression is re-evaluated and any change in the value is conveyed to the client by using a client-side scripting language command. In this way, the corresponding display from control tree 502 is changed appropriately.

When the node is an Assignment node, the expression is re-evaluated and any change in the value results in a change in the associated VarBinding. This VarBinding change is added to a list of changed VarBindings.

When the node is a Block Holder, the expression is re-evaluated, and any change in the value is used by the Block Holder to decide whether it needs to alter the set of contained blocks. The type of alteration is specific to a Block. When the Block Holder is an ‘if’ statement, and if the condition expression of the ‘if’ Block Holder has changed from true to false, then the Block Holder removes the ‘then’ Block and adds the ‘else’ Block. Further, when the Block Holder is ‘for-each’ statement, the ‘for-each’ Block Holder compares the new list with the old list, and appropriately removes old Blocks, adds new Blocks and/or re-orders existing Blocks. Furthermore, when the Block Holder is ‘make-comp’ Block Holder; the ‘make-comp’ Block Holder checks if the name of a component to be instantiated has been changed. When the name of the component to be instantiated is changed, the Block Holder removes the old Block under the component, and instantiates the new component Block based on the new component name. If the arguments being passed to the component are changed, then those changes are passed on to the component specific part of control tree 502 for re-evaluation of the tree.

It should be noted that in all the cases when a Block is removed from control tree 502, all the VarBindings generated by the Assignment statements within that Block are also removed from the VarBindings chain. These VarBindings are always contiguous within the chain. The VarBindings belonging to the added/removed block are treated as ‘changed’ VarBindings. Further, all such changes also result in additions in the list of changed VarBindings.

The concept of VarBindings is further illustrated in conjunction with Table 1 and Table 2. Table 1 below explains the VarBindings that correspond to control tree nodes:

TABLE 1
Display tree nodes and corresponding VarBinding pointers

| | VarBinding |
|---|---|
| Control Tree Node | Pointer |
| Head | −1 |
| Body | −1 |
| Variable-1 declaration | −1 |
| Variable-1 assignment: Variable-1 = x | −1 |
| Server action-1 | 0 |
| Block-1 | 0 |
| Variable-2 declaration | 0 |
| Variable-2 assignment: Variable-2 = y | 0 |
| Variable-3 declaration | 1 |
| Variable-3 assignment: Variable-3 = z | 1 |
| Server action2 | 2 |
| Expression Holder-1 | 2 |

It can be seen from Table 1 that the value of the VarBinding pointer is increased whenever an Assignment Statement for a variable is encountered. However, any declaration of a new variable or the insertion of Blocks does not result in the increment of a VarBinding pointer value. It should be noted that the example provided above is for illustrative purposes. It will be apparent to a person skilled in the art that numerous other possibilities of code segments and corresponding VarBindings are possible, and they do not restrict the scope of the invention in any way. Table 2 lists the corresponding values of variables:

TABLE 2
VarBindings chain

| Variable | Value |
|---|---|
| Variable-1 | x |
| Variable-2 | y |
| Variable-3 | z |

Various embodiments of the invention described above can be utilized to develop various web-based applications that run in a browser. These applications include, but are not limited to, e-mail clients, instant messengers, Customer Relationship Management (CRM) applications such as Lead Management applications and Sales and Marketing applications, Web-based helpdesks, Knowledge banks, Project Management Applications, Workflow applications, Inventory Management and Enterprise Resource Planning (ERP) applications, and virtual operating systems configured to run in a browser. The invention facilitates features such as real-time data validation, auto-completion, partial data submit, and auto-refresh for the applications of the invention mentioned above. Further, various similar applications running on a standalone data processing device can be developed.

An advantage of the invention is that the templating system updates content in real time. Another advantage of the invention is that the templating system detects changes in the data and generates minimal changes in the result document to reflect these changes automatically. Further, the templating system eliminates the probability of a human programmer writing a code to check for, and reflect the desired changes in the underlying data. Yet another advantage of the invention is that the templating system generates web-based applications that reflect any changes to the data or layout and structure of the web page in real-time. The templating system is also compatible with various markup and scripting languages.

The templating system and the method for dynamically updating web content, as described in the present invention or any of its components, may be embodied in the form of a computer system. Typical examples of a computer system include a general-purpose computer, a programmed microprocessor, a micro-controller, a peripheral integrated circuit element, and other devices or arrangements of devices that are capable of implementing the steps that constitute the method of the present invention.

The computer system comprises a computer, an input device, a display unit and the Internet. The computer comprises a microprocessor, which is connected to a communication bus. The computer also includes a memory, which may include Random Access Memory (RAM) and Read Only Memory (ROM). Moreover, the computer system comprises a storage device, which can be a hard disk drive or a removable storage drive such as a floppy disk drive, an optical disk drive, etc. The storage device can also be other similar means for loading computer programs or other instructions into a computer system. Further, the computer system includes a communication unit, which enables the computer to connect to other databases and the Internet through an I/O interface. The communication unit also enables the transfer and reception of data from other databases, and may include a modem, an Ethernet card, or any similar device that enables the computer system to connect to databases and networks such as LAN, MAN, WAN and the Internet. The computer system facilitates inputs from a user through an input device that is accessible to the system through an I/O interface.

The computer system executes a set of instructions that are stored in one or more storage elements, to process input data. The storage elements may also hold data or other information as desired, and may be in the form of an information source or a physical memory element present in the processing machine.

The set of instructions may include various commands that instruct the processing machine to perform specific tasks such as the steps that constitute the method of the present invention. The set of instructions may be in the form of a software program. The software may be in the form of a collection of separate programs, a program module with a larger program, or a portion of a program module, as in the present invention. The software may also include modular programming in the form of object-oriented programming. Processing of input data by the processing machine may be in response to users' commands, the result of previous processing, or a request made by another processing machine.

While the preferred embodiments of the invention have been illustrated and described, it will be clear that the invention is not limited to these embodiments only. Numerous modifications, changes, variations, substitutions and equivalents will be apparent to those skilled in the art, without departing from the spirit and scope of the invention.

What is claimed is:

1. A method for processing a template document in a client-server architecture, for generating a result document and keeping the result document updated with the changes in a data model at a run time, the method comprising:
compiling the template document to form server side constructs and client side constructs;
executing the server side constructs using the data model;
executing the client side constructs, to generate the result document;
generating a set of commands by the server side constructs, when there is a run time change in the data model;
executing the set of commands by the client side constructs; and
dynamically updating the result document, to display the run time changes in the data model.

2. The method according to claim 1, wherein the step of compiling the template document further comprises identifying a plurality of control constructs of the template document as a plurality of blocks, a plurality of block holders, plurality of expression holders, a plurality of variable declarations, a plurality of variable assignments and a plurality of server actions.

3. The method according to claim 2 further comprising identifying a fixed markup language part of the template document.

4. The method according to claim 2 further comprising forming the server side constructs, from the control constructs, in a programming language.

5. The method according to claim 4 further comprising maintaining the server side constructs at the server side.

6. The method according to claim 1, wherein the step of compiling the template document further comprises using a fixed markup language part, the plurality of blocks and the plurality of block holders to generate a script language code.

7. The method according to claim 6 further comprising forming the client side constructs in the script language code.

8. The method according to claim 7 further comprising sending the client side constructs to the client side.

9. The method according to claim 1, wherein the step of executing the server side constructs further comprises identifying active server side constructs, wherein the active server side constructs are the server side constructs that capture the run time changes in the data model.

10. The method according to claim 9 further comprising:
generating a control tree data structure, wherein the control tree data structure is composed of the active server side constructs; and
maintaining the control tree data structure to accommodate further changes in the data model.

11. The method according to claim 1, wherein generating the set of commands further comprises:
processing the control tree data structure;
generating the set of commands for the client side, to identify active client side constructs; and
mapping the active client side constructs with the active server side constructs, to capture the run time changes in the data model at the client side.

12. The method according to claim 1, wherein executing the client side constructs further comprises
generating a display tree data structure, wherein the display tree data structure is composed of the active client side constructs; and
updating the display tree data structure with the active client side constructs that map on to the active server side constructs, wherein the active server side constructs capture the further changes in the data model.

13. The method according to claim 12 further comprising:
processing the display tree data structure;
determining the sequence of execution of the active client side constructs; and
generating the result document.

14. The method according to claim 1, wherein updating the result document further comprises automatically capturing the run time changes in the data model.

15. A method for processing a template document in a client-server architecture, for generating a result document and keeping the result document updated with the changes in a data model at a run time, the method comprising:
identifying a fixed markup language part of the template document for client side constructs;
generating a script language code for the client side constructs;
identifying a plurality of control constructs of the template document as a block, a block holder, an expression holder, a plurality of variable declarations, a plurality of variable assignments and a plurality of server actions;
forming the server side constructs from the control constructs;
creating a control tree data structure using the server side constructs, to capture run time changes in the data model;
processing the control tree data structure that generates a set of commands to the client side;
executing the set of commands at the client side to generate a display tree data structure;
processing the display tree data structure to generate the result document, wherein the result document captures the run time changes in the data model; and
dynamically updating the result document, to display the run time changes in the data model.

16. A computer program product for use with a computer, the computer program product comprising a computer usable medium having a computer readable program code embodied therein for processing a template document in a client-server architecture, for generating a result document and keeping the result document updated with the changes in a data model at a run time, the computer program code performing:
compiling the template document to form server side constructs and client side constructs;
executing the server side constructs using the data model;
executing the client side constructs, to generate the result document;
generating a set of commands by the server side constructs, when there is a run time change in the data model;
executing the set of commands by the client side constructs; and
dynamically updating the result document, to display the run time changes in the data model.

17. The computer program product according to claim 16, wherein compiling the template document further comprises identifying a plurality of control constructs of the template document as a plurality of blocks, a plurality of block holders, plurality of expression holders, a plurality of variable declarations, a plurality of variable assignments and a plurality of server actions.

18. The computer program product according to claim 17 further comprising program code for identifying a fixed markup language part of the template document.

19. The computer program product according to claim 17 further comprising program code for forming the server side constructs, from the control constructs, in a programming language.

20. The computer program product according to claim 19 further comprising program code for maintaining the server side constructs at the server side.

21. The computer program product according to claim 16, wherein compiling the template document further comprises using a fixed markup language part, the plurality of blocks and the plurality of block holders to generate a script language code.

22. The computer program product according to claim 21 further comprising program code for forming the client side constructs in the script language code.

23. The computer program product according to claim 21 further comprising program code for sending the client side constructs to the client side.

24. The computer program product according to claim 16, wherein executing the server side constructs further comprises identifying active server side constructs, wherein the active server side constructs are the server side constructs that capture the run time changes in the data model.

25. The computer program product according to claim 16 further comprising program code for:
generating a control tree data structure, wherein the control tree data structure is composed of the active server side constructs; and
maintaining the control tree data structure to accommodate further changes in the data model.

26. The computer program product according to claim 16, wherein generating the set of commands further comprises:
processing the control tree data structure;
generating the set of commands for the client side, to identify active client side constructs; and
mapping the active client side constructs with the active server side constructs, to capture the run time changes in the data model at the client side.

27. The computer program product according to claim 16, wherein executing the client side constructs further comprises
generating a display tree data structure, wherein the display tree data structure is composed of the active client side constructs; and
updating the display tree data structure with the active client side constructs that map on to the server side constructs, wherein the server side constructs capture the further changes in the data model.

28. The computer program product according to claim 27 further comprising program code for:
processing the display tree data structure;
determining the sequence of execution of the active client side constructs; and
generating the result document.

29. The computer program product according to claim 16, wherein updating the result document further comprises automatically capturing the run time changes in the data model.
